(19) United States
(12) Patent Application Publication
(10) Pub. No.: US 2024/0099921 A1
(43) Pub. Date: Mar. 28, 2024

(54) ADJUSTABLE, MULTI-FUNCTIONAL SHOULDER STRETCHING DEVICE

(71) Applicant: MEDI-DYNE HEALTHCARE PRODUCTS, LTD., Colleyville, TX (US)

(72) Inventors: Andrew SAWYERS, Colleyville, TX (US); Craig DIGIOVANNI, Colleyville, TX (US); Blair PATTON, Colleyville, TX (US)

(73) Assignee: MEDI-DYNE HEALTHCARE PRODUCTS, LTD., Colleyville, TX (US)

(21) Appl. No.: 18/528,317

(22) Filed: Dec. 4, 2023

Related U.S. Application Data
(63) Continuation-in-part of application No. 18/024,006, filed on Jan. 1, 0001.
(60) Provisional application No. 63/268,706, filed on Mar. 1, 2022.

(30) Foreign Application Priority Data
Feb. 23, 2023 (WO) PCT/US23/63096

(51) Int. Cl. A61H 1/02

(52) U.S. Cl. CPC A61H 1/0281; A61H 2201/0192; A61H 2201/1638

(57) ABSTRACT

A shoulder stretching device can be used to stretch or strengthen targets muscles before or after surgery, after an injury, or for workouts. The device is multi-functional and adjustable. The device can include a longitudinal member, a top handgrip and forearm member operatively connected to the longitudinal member, a curved elbow member, and a bottom transverse member indirectly connected to the longitudinal member via the curved elbow member. A lateral adjuster can be fan-shaped and include a plurality of locking mechanism receivers that allow the longitudinal member to be angled closer to or farther away from the bottom transverse member. The handgrip and forearm members can be adjusted along a length and can rotate about the longitudinal member. A user can adjust the location and angles of the members in relation to each other and placement of the handgrip for adjustability and to use the device in a multi-functional way.

### TECHNICAL FIELD

The field relates to a multi-functional shoulder stretching device. The device is adjustable and can be used in a variety of positions around a user's body to stretch a variety of muscles.

### BRIEF DESCRIPTION OF THE FIGURES

The features and advantages of the embodiments will be more readily appreciated when considered in conjunction with the accompanying figures. The figures are not to be construed as limiting any of the embodiments.

FIG. 1 is a front, perspective view of a shoulder stretching device according to certain embodiments.

FIGS. 1A and 1B are an exploded view of an adjustment lock of FIG. 1 according to different embodiments.

FIG. 2 is an exploded view of a lateral adjuster and adjustment lock according to certain embodiments.

FIGS. 3A and 3B are side views of the shoulder stretching device showing a handgrip being repositioned relative to a longitudinal member according to certain embodiments.

FIG. 4 is a side view of the shoulder stretching device showing a handgrip being repositioned relative to a longitudinal member according to certain other embodiments.

FIGS. 5A-5D are front, perspective views of the shoulder stretching device showing various adjustments for varying the difficulty level according to certain embodiments.

FIGS. 6-11B are perspective views of the shoulder stretching device showing how the device can be used by a user according to certain embodiments.

### DETAILED DESCRIPTION

Stretching and exercising the muscles, joints, tendons, etc. in the shoulder region may be desirable or necessary for a variety of reasons. For example, stretching exercises are frequently used if an injury occurs to possibly avoid surgery. Post-operative exercises are also frequently ordered to help stretch and strengthen muscles after surgery. Athletes and people who lift weights also frequently stretch targeted muscles before and/or after a workout.

A doctor may order a patient to undertake physical therapy, for example after an injury or surgery. Typically, the patient meets with the physical therapist in person and is shown how to properly perform various stretching and/or strengthening exercises. Oftentimes, specialized equipment can only be used at the physical therapist's building. Therefore, for shoulder exercises, the patient may have to use bands or other household items (e.g., broom sticks, hammers, or pipes) at home to simulate the specialized equipment. Currently, no specialized shoulder stretching device exists that can be used by a physical therapist, for example, during in-person instruction and also be used at home by the patient.

The targeted muscles to be stretched can differ and can change. For example, dead lifts may work different muscles than bench press. Accordingly, the targeted muscles to be stretched can change from workout to workout. The targeted muscles may also change during a course of physical therapy as a patient progresses through treatment. Current device designs are not multi-functional and do not allow a user to stretch and/or strengthen a variety of muscles in and around the shoulder region. Moreover, current designs do not allow the device to be customized based on a user's size to provide a proper fit of the device to each patient for the maximum effect. Moreover, current designs are not progressive and do not provide a measurable range of positions that allow a user to increase or decrease the difficulty level or the amount of stretch and/or strengthening.

Thus, there is a need for a shoulder stretching device that solves the problems of current designs. It has been discovered that a shoulder stretching device can be used during treatment and at home, allows more muscles or tendons to be stretched and strengthened, is multi-functional, customizable, and allows a user to increase or decrease the amount of stretch or strengthening. It is to be understood that reference to “muscles” is not limited to only muscles, but also includes ligaments, tendons, joints, etc. without the need to repeat the entire list throughout.

A shoulder stretching device can include a longitudinal member; a handgrip operatively connected to a top end of the longitudinal member; a curved elbow member connected to a bottom end of the longitudinal member; a lateral adjuster operatively connected to the longitudinal member at a location between the handgrip and the curved elbow member; and a bottom transverse member indirectly connected to the longitudinal member via the curved elbow member, wherein adjustment of the lateral adjuster moves the handgrip closer to or farther away from the bottom transverse member.

It is to be understood that the discussion of any of the embodiments regarding the shoulder stretching device is intended to apply to all of the apparatus and method embodiments without the need to repeat the various embodiments throughout.

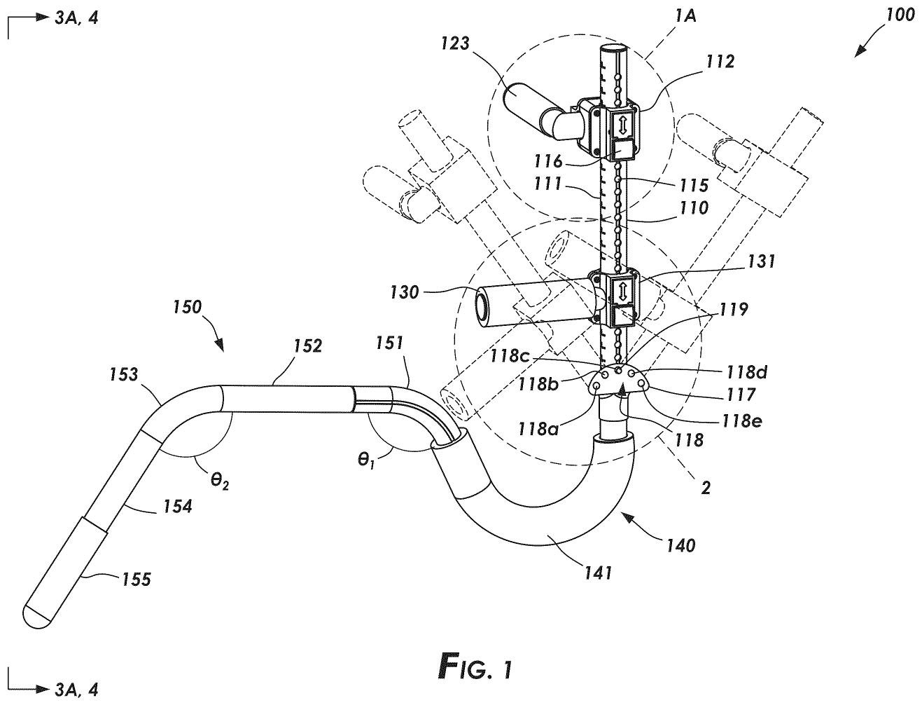

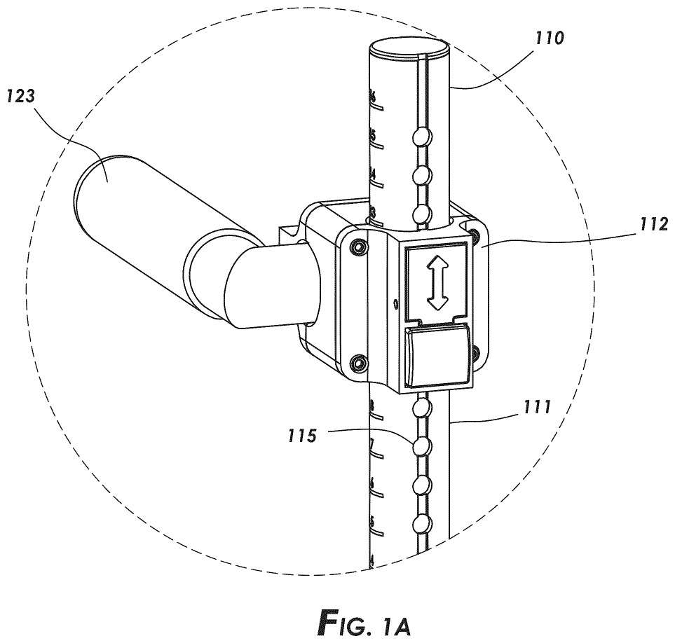

Turning to the figures, FIG. 1 shows a shoulder stretching device 100 according to certain embodiments. The shoulder stretching device can include a substantially straight longitudinal member 110. The longitudinal member 110 can have a variety of lengths ranging for example, from 12 to 48 inches (30.5 to 121.9 centimeters “cm”). The longitudinal member 110 can have a top portion, middle portion, and a bottom potion (not labeled). The longitudinal member 110 can be cylindrical in shape and include a longitudinal axis. The longitudinal member 110 can be solid, hollow, or include both solid and hollow portions.

Beginning at a top portion of the longitudinal member 110, the shoulder stretching device 100 can include a handgrip 123 located near the top portion of the longitudinal member 110. The handgrip 123 can be cylindrical in shape or other shapes, such as triangular or square. The handgrip 123 can be permanently attached to a vertical adjustment lock 112 and can be oriented perpendicular to the longitudinal axis of the longitudinal member 110. The handgrip 123 can include a slip-resistant material surrounding all or a portion of the handgrip 123. As shown in FIGS. 1 and 1A for example, the handgrip 123 can be permanently attached to a side of a vertical adjustment lock 112 and can include a first straight portion extending away from the vertical adjustment lock 112, an angled portion (shown as being a 90° angle but can be other angles as well), and a second straight portion extending back from the first straight portion. The length of the first straight portion can be in a range of 1 to 5 inches. The length of the second straight portion can be in a range of 1 to 12 inches. As shown in FIGS. 1B and 3A-4, the handgrip 123 can be permanently attached to a back of a vertical adjustment lock 112 and can include a first straight portion extending away from the back of the vertical adjustment lock 112. According to this embodiment, the handgrip 123 does not include an angled portion or a second straight portion extending back from the first straight portion.

The handgrip 123 can be moved vertically farther down or closer to the top end of the longitudinal member 110, for example by releasing the vertical adjustment lock 112 and sliding the handgrip 123 and the vertical adjustment lock 112 along the longitudinal member 110. The top end of the longitudinal member 110 can include one or more adjustment indicators 111 to aid a user in a desired placement of the handgrip 123 along the longitudinal member 110. The desired placement of the handgrip 123 along the longitudinal member 110 can be based in part on the length of a user's forearm such that the user is able to securely grasp the handgrip 123 when in use.

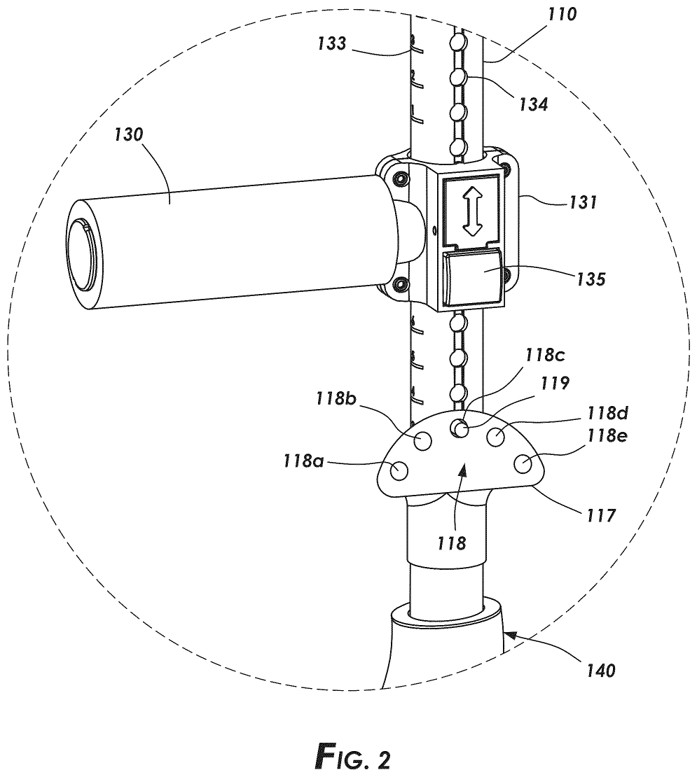

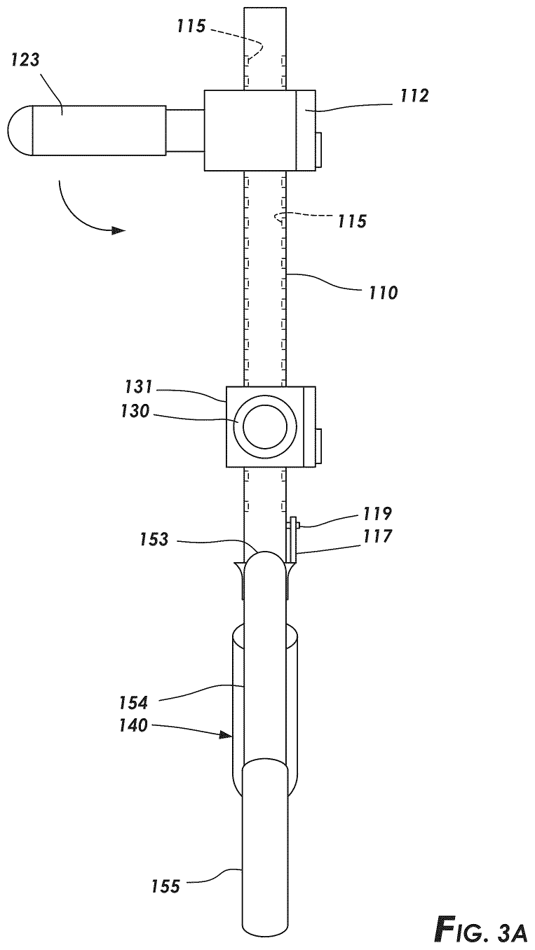

FIG. 1A is an exploded view of the vertical adjustment lock 112 according to certain embodiments. FIG. 1B shows the vertical adjustment lock 112 according to certain other embodiments. The vertical adjustment lock 112 can include one or more components that allow movement of the handgrip 123 in a longitudinal direction with respect to the longitudinal axis of the longitudinal member 110. The one or more components of the lock 112 can also be used to allow rotation of the handgrip 123 about the longitudinal member 110, for example, as shown in FIGS. 3A and 3B. The one or more components of the lock 112 can also be used to allow the handgrip 123 to be removed from and re-attached to the longitudinal member 110 to change the orientation of the handgrip, for example, as shown in FIG. 4. The lock 112 can include a locking mechanism that secures the handgrip 123 in the desired location and orientation in relation to the longitudinal member 110 after adjustment, for example, by using the adjustment indicators 111.

According to any of the embodiments and as shown in FIG. 1B, the vertical adjustment lock 112 can include a concave body (not labeled) configured to receive the longitudinal member 110. The concave body can include an opening and two protrusions extending away from the concave body. The vertical adjustment lock 112 can include a threaded rod 113 that traverses through both of the protrusions and can matingly engage with threads on the protrusions. A hand knob 114 can be attached to the threaded rod 113 at one end. The hand knob 114 can be turned counterclockwise in relation to the threaded rod 113 to release tension on the longitudinal member 110. In this manner, the handgrip 123 can then be moved vertically in relation to the longitudinal axis of the longitudinal member 110 to a desired location. Once the handgrip 123 is moved to the desired location, the hand knob 114 can be rotated clockwise in relation to the threaded rod 113 to create tension on the longitudinal member 110 in order to lock the handgrip 123 at the desired location.

According to any of the embodiments and as shown in FIGS. 1, 3A, 3B, and 4, the longitudinal member 110 can include a plurality of locking mechanism receivers 115 located along an outside of the top end of the longitudinal member 110 and adjacent to the adjustment indicators 111. The locking mechanism receivers 115 can be cup-shaped indentations or holes that penetrate from an outside of the longitudinal member 110 through to an inside of the member 110 (in the case the member 110 is hollow on the inside). The vertical adjustment lock 112 can include release button 116. The release button 116 can be depressed, which causes an internal protrusion from disengaging with the locking mechanism receivers 115, thereby allowing the movement of the handgrip 123 vertically along or rotationally about the longitudinal axis of the longitudinal member 110 to a desired location. Once the handgrip 123 is moved to the desired location, depression of the release button 116 can be removed to cause the internal protrusion to engage with a particular locking mechanism receiver 115 in order to lock the handgrip 123 at the desired location. It is possible that after the depression of the release buttons is removed, a user may need to move the handgrip 123 slightly up or down the longitudinal member 110 until there is an indication that the internal protrusion has completely engaged with the locking mechanism receivers 115 (e.g., by hearing an audible click or inability to move the member any farther along the longitudinal member).

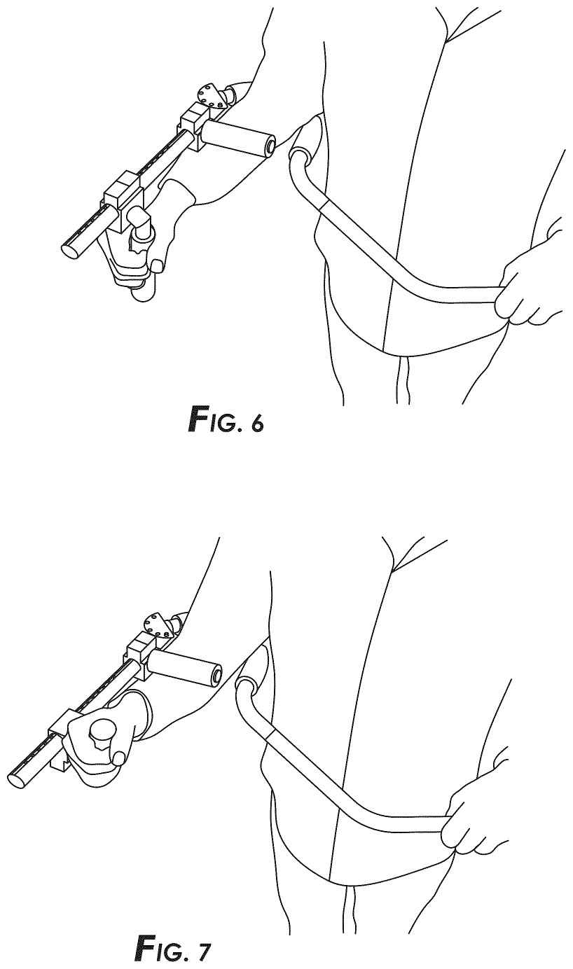

As can be seen by way of example with reference to FIGS. 3A-4, the handgrip 123 can be moved to point in different directions in relation to the longitudinal member 110. By way of example and with reference to FIGS. 6 and 7, the handgrip 123 is pointing down during use as shown in FIG. 6. If a user desires to adjust the handgrip 123 to be pointing up as shown in FIG. 7, then the user can release the release button 116 (as shown in FIG. 1A) or use the hand knob 114 to loosen the vertical adjustment lock 112 (as shown in FIG. 1B) to either rotate the handgrip 123 180° clockwise or counterclockwise around the longitudinal axis of the longitudinal member 110 as shown in FIGS. 3A and 3B, or the user can remove the entire handgrip 123 and vertical adjustment lock 112 as shown in FIG. 4 and flip the handgrip 123 over the longitudinal member 110 and then reattach the handgrip 123 onto the longitudinal member 110.

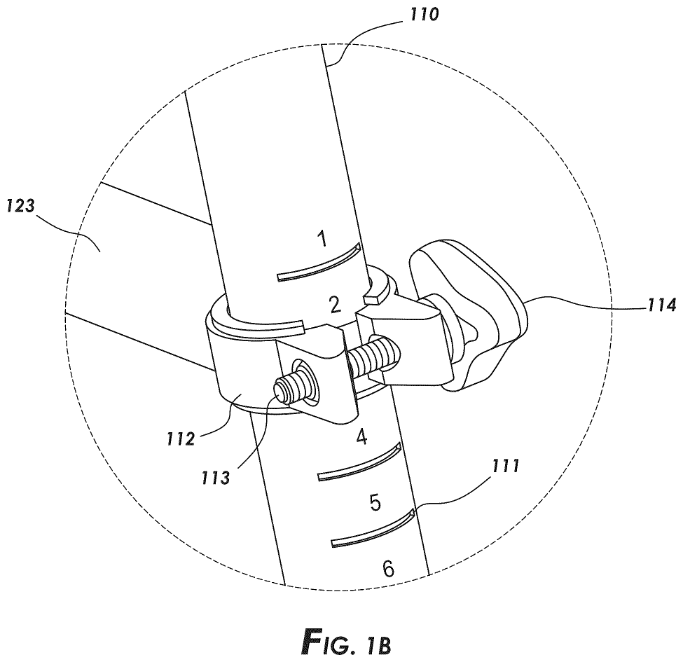

With reference to FIGS. 1 and 2 and moving farther down the longitudinal member 110 towards a bottom portion, the shoulder stretching device 100 can include a forearm member 130. The forearm member 130 can be adjustably connected to the longitudinal member 110 via an adjustment lock 131. The adjustment lock 131 can be configured like the vertical adjustment lock 112 as shown in FIG. 1 or 1B and as described above. As shown in FIG. 2, for example, the bottom portion of the longitudinal member 110 can include a plurality of adjustment indicators 133 and a plurality of locking mechanism receivers 134. An adjustment lock 131 can include a release button 135 or a threaded rod and hand knob (not shown or labeled in FIG. 2). The forearm member 130 can be adjusted and moved vertically along the longitudinal axis of the longitudinal member 110 using the components like as discussed above. The forearm member 130 can also be adjusted rotationally around the longitudinal axis of the longitudinal member 110 like as discussed above. The forearm member 130 can be a rigid rod-like member as shown or a strap (not shown). All of or a portion of the forearm member 130 can be covered with padding 132 located around an outside of the forearm member.

The plurality of adjustment indicators 111/133 can be in the form of lines or notches, or lines or notches and numbers. The numbers can be positive integers and can have 1-unit increments (i.e., 1, 2, 3, 4, etc.)or 2- or 3-unit increments (i.e., 2, 4, 6, etc. or 1, 3, 6, 9, etc.) between each line and number. The increments can represent a unit of length. Accordingly, the distance between each indicator can represent the unit increments in inches or fractions of an inch. By way of a first example, the distance between 1-unit increments for an indicator numbered 1 and indicator numbered 2 can correspond to a distance of 1 inch or 0.5 inches. By way of a second example, the distance between 2-unit increments for an indicator numbered 2 and indicator numbered 4 can correspond to a distance of 1 inch or 2 inches. A user, with or without instruction from a physical therapist or other instructor, can adjust the handgrip and forearm member to a desired location for a specific exercise based on their arm and torso lengths and then remember or write down the specific number for each of the plurality of adjustment indicators. In this manner, when switching between exercises, a user can quickly adjust the handgrip and forearm member to the appropriate locations.

Moving farther down the longitudinal member 110, a lateral adjuster 117 can be located below the forearm member 130. The lateral adjuster 117 can include a plurality of locking mechanism receivers 118. The lateral adjuster 117 can be fan-shaped and the plurality of locking mechanism receivers 118 can form an arch along an upper portion of the lateral adjuster 117. The number of locking mechanism receivers 118 can be selected such that a broad range of angles of the handgrip 123 in relation to other components of the device 100 are possible. Although shown with 5 locking mechanism receivers 118 (i.e., 118a-118e), it is to be understood that fewer than 5 or more than 5 can be used. The longitudinal member 110 can include a hinge that is located directly below the lateral adjuster 117 such that the longitudinal member 110 can be tilted closer to or farther away from the bottom transverse member 150.

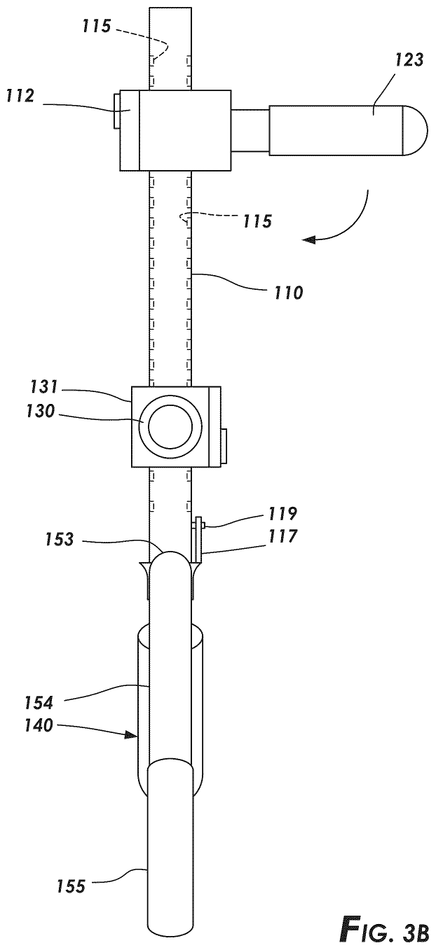

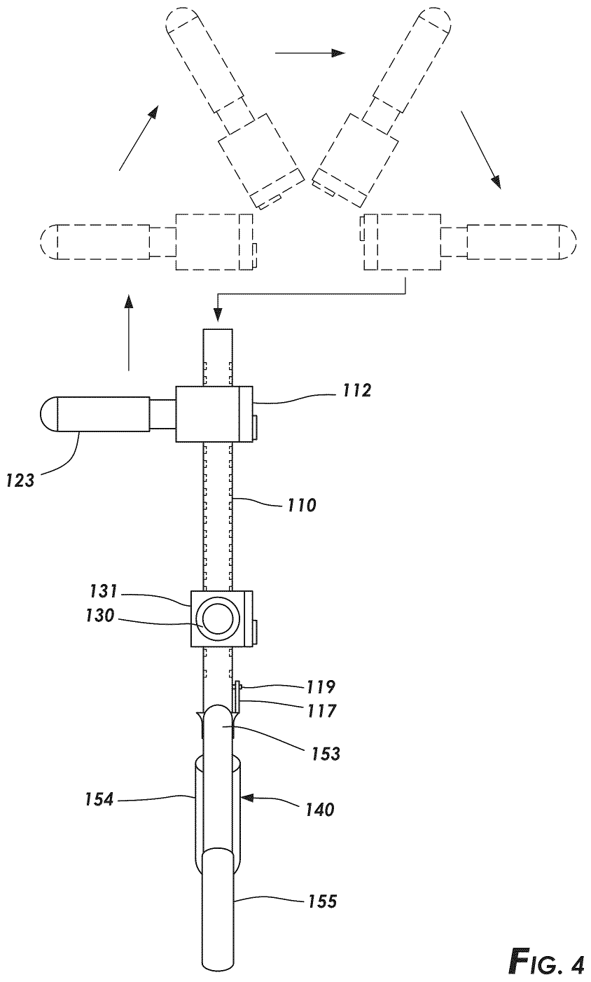

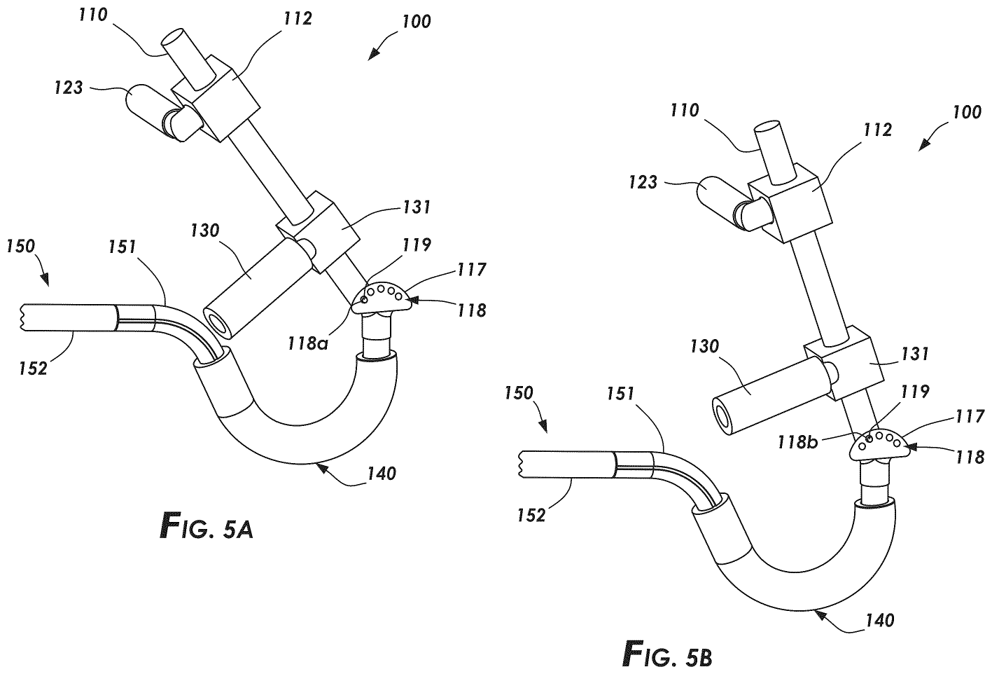

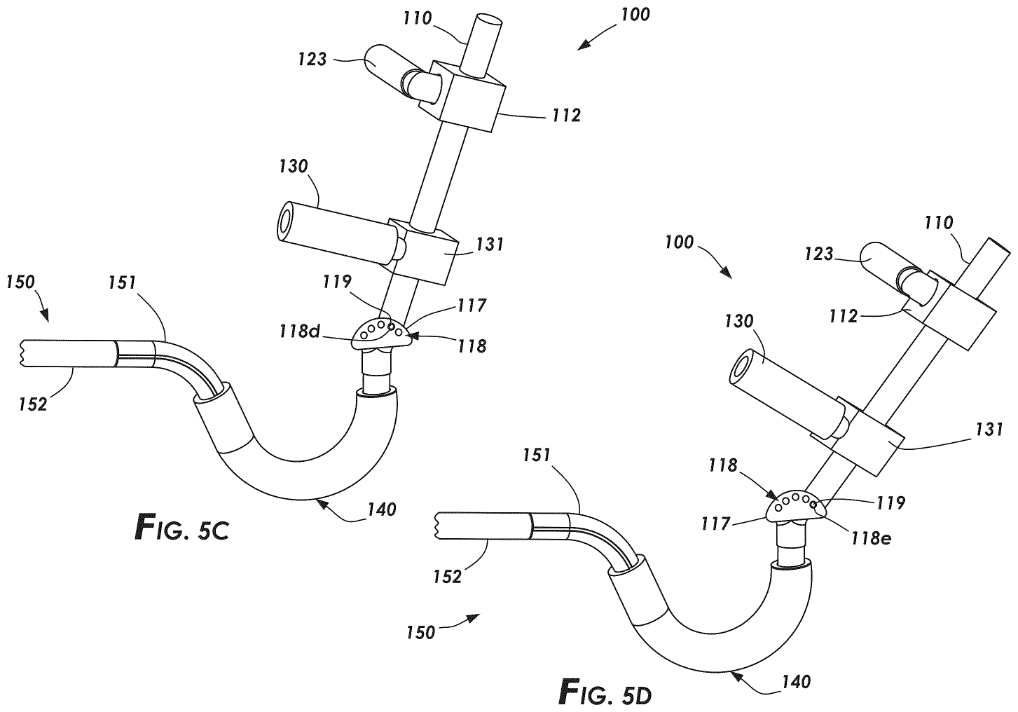

In order to move the longitudinal member 110 to an angle in relation to the bottom transverse member 150, a release button 119 that is permanently attached to the longitudinal member 110 at a location adjacent to the locking mechanism receivers 118 can be depressed to push the release button 119 out of connection through one of the locking mechanism receivers 118. Once disengaged, the longitudinal member 110 can be tilted to move the handgrip 123 farther away from or closer to the bottom transverse member 150. By way of example and as shown in FIGS. 5A and 5B, the release button 119 can be depressed and the longitudinal member 110 can be tilted to position the handgrip 123 closer to the bottom transverse member 150 for a beginner's minimum difficulty level shown in FIG. 5A with the release button 119 being secured in the first locking mechanism receiver 118a; or to position the handgrip 123 slightly farther away from the bottom transverse member 150 for a beginner's maximum difficulty level shown in FIG. 5B with the release button 119 being secured in the second locking mechanism receiver 118b.

As shown in FIGS. 5C and 5D, the longitudinal member 110 can be tilted away from the bottom transverse member 150 with the release button 119 being secured in the fourth locking mechanism receiver 118d for an advanced minimum difficulty level shown in FIG. 5C or with the release button 119 being secured in the fifth locking mechanism receiver 118e for an advanced maximum difficulty level shown in FIG. 5D. Accordingly, the shoulder stretching device 100 is multi-functional and adjustable. It is to be understood that each of the handgrip 123, the longitudinal member 110 about the lateral adjuster 117, and the forearm member 130 can be adjusted to a desired position independently, wherein adjustment of one of the members may not require adjustment of the other member.

With reference and moving farther down the longitudinal member 110 below the lateral adjuster 117, the shoulder stretching device 100 can include a curved elbow member 140. As shown, the elbow member 140 can have a U-shaped configuration. The elbow member 140 can be used to receive a user's elbow or portion of the upper arm when in use. Padding 141 can be located wholly or partially around an outside of the elbow member 140. In this manner, a user's elbow and portions of a user's arm can be cushioned during use. The bottom end of the longitudinal member 110 can be located adjacent to a first end of the curved elbow member 140. The longitudinal member 110 can be indirectly connected to the curved elbow member 140, for example via the hinge of the lateral adjuster 117. The dimensions and curvature of the elbow member can vary. The curved elbow member can be solid or hollow.

The shoulder stretching device 100 also includes the bottom transverse member 150. The bottom transverse member 150 can extend from a second end of the curved elbow member 140. The bottom transverse member 150 can include a first curved portion 151, a first straight portion 152, a second curved portion 153, and a second straight portion 154. The first curved portion 151 can be located adjacent to and extend from the second end of the elbow member 140. The bottom transverse member can be directly connected to the curved elbow member or can be formed as an integral part of the longitudinal member and the curved elbow member as a single unit. It is to be understood that reference to a first end or second end is for illustrative, directional purposes only and does not require distinct, separate parts that are attached to one another as some of the components can be formed as a single unit.

The first curved portion 151 and the first straight portion 152 can form an angle θ₁. The second straight portion 154 of the bottom transverse member 150 can be offset a desired distance from the bottom of the curve of the curved elbow member 140. The bottom transverse member can have a variety of lengths. The first straight portion 152, second curved portion 153, and second straight portion 154 can form an angle θ₂. Angle θ₁ and angle θ₂ can be the same or different and can range from 95° to 150°. The angles θ₁ and θ₂ as well as the lengths of the first straight portion 152 and second straight portion 154 can be selected such that the bottom transverse member 150 can be positioned comfortably about a user's body during use. By way of example, the length of the first straight portion 152 or the second straight portion 154 can be selected based on the bodyweight of the user (e.g., longer lengths for users weighing more than 200 pounds compared to users weighing less than 200 pounds). The length of the first straight portion 152 and second straight portion 154 can range, for example, from 3 to 48 inches (7.6 to 121.9 cm). The lengths of the first straight portion 152 and second straight portion 154 can be the same or different. For example, the length of the second straight portion 154 can be less than the length of the first straight portion 152.

A handgrip 155 can be located at the terminal end of the second straight portion 154. The handgrip 155 can include a slip-resistant covering surrounding all or a portion of the handgrip 155. The slip-resistant covering for the handgrips 123/155 can be made from materials such as rubber, soft plastics, neoprene, urethanes, or foam materials. The thickness of the slip-resistant covering can range from 0.1 to 1.5 inches (0.3 to 3.8 cm) and can be selected to provide comfort to a user and proper use of the device. The handgrips can include etching, for example in the form of a pattern, in lieu of the slip-resistant covering to prevent a user's hand from slipping during use. The handgrip 155 can be interchangeable with other handgrips to provide additional functionality to the device. By way of example, a first handgrip can be removed from the second straight portion 154 and interchanged with a second handgrip. The second handgrip can have a length that is greater than the first handgrip for example. The second handgrip can also be angled in relation to the second straight portion 154 whereas the first handgrip may not be angled. The interchangeable handgrips 155 are another example of the versatility and multi-functionality of the device to provide a wide range of exercises for a wide range of targeted muscles.

The various components of the shoulder stretching device 100 can be made from rigid materials, including but not limited to polymeric plastics, thermoset plastics, metals, or metal alloys, fiberglass, or carbon fiber. As used herein, the term “metal alloy” means a mixture of two or more elements, wherein at least one of the elements is a metal. The other element(s) can be a non-metal or a different metal. An example of a metal and non-metal alloy is steel, comprising the metal element iron and the non-metal element carbon. An example of a metal and metal alloy is bronze, comprising the metallic elements copper and tin. As used herein, the term “metal” and all grammatical variations thereof means any substance that comprises a metal, which includes pure metals and metal alloys.

Examples of plastics include but are not limited to low-density polyethylene (LDPE), high-density polyethylene (HDPE), polyethylene terephthalate (PET or PETE), polyvinyl chloride (PVC), polypropylene (PP), polystyrene (PS), high-impact polystyrene (HIPS), acrylonitrile butadiene styrene (ABS), cellulose-acetate-butyrate (Cab), polycarbonate (PC), or polyvinylidene fluoride or polyvinylidene difluoride (PVDF). Examples of metals include but are not limited to iron, aluminum, steel, carbon steel, stainless steel, zinc, lead, copper, tin, brass, nickel, and chromium. While all of the members of the shoulder stretching device 100 (i.e., the longitudinal member 110, handgrip 123, forearm member 130, elbow member 140, and bottom transverse member 150) can be made from the same materials, it is also possible to have some of the members made from a different material than the other members. Moreover, one or more of the members can also include a reinforcing layer that is made from a material having a higher ductile or tensile strength compared to the material of the member. Preferably, a given member is made from the same material. For example, the first curved portion 151, first straight portion 152, second curved portion 153, and second straight portion 154 of the bottom transverse member 150 are preferably made from the same material. If different materials are used for different members, then the shoulder stretching device 100 can be manufactured such that the longitudinal member 110, elbow member 140, and bottom transverse member 150 are considered a single unit. The longitudinal, elbow, and bottom transverse members can also be manufactured such that the three members can be removably attached to each other.

The members of the shoulder stretching device 100 can all be cylindrical in shape having a circular cross-section or other geometric cross-sectional shapes, such as a triangle, square, or rectangle. The members can have the same or different diameters ranging from 0.25 to 4 inches (0.63 to 10 cm). As discussed above, the members can be solid or hollow. Additionally, a given member (e.g., the longitudinal member 110) can be hollow, while a different member (e.g., the bottom transverse member 150) can be solid. The diameter of the members can be selected based on whether the member is solid or hollow and to provide structural integrity to the device during use. By way of example, for solid members, the diameter may only need to be 0.25 inches to provide structural integrity; while for hollow members, the diameter may need to be 4 inches to provide structural integrity.

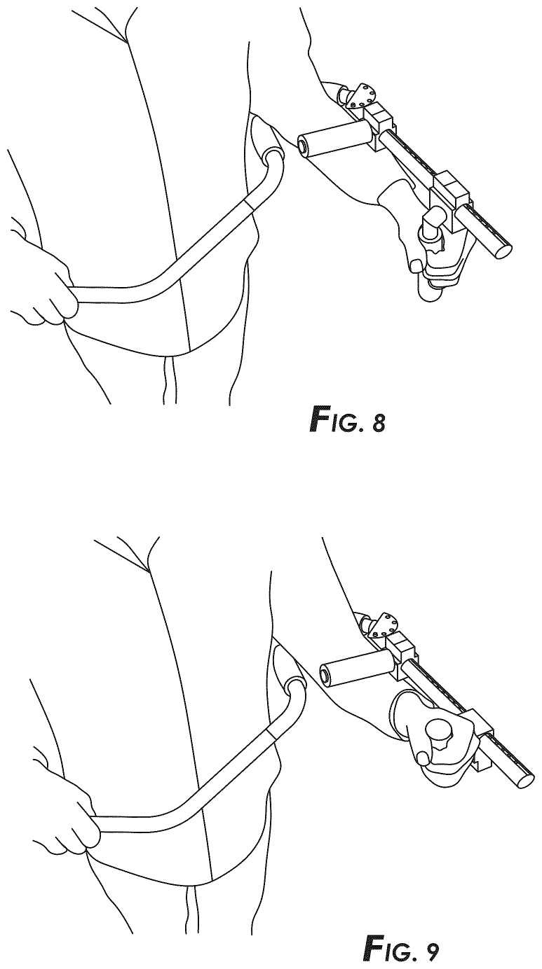

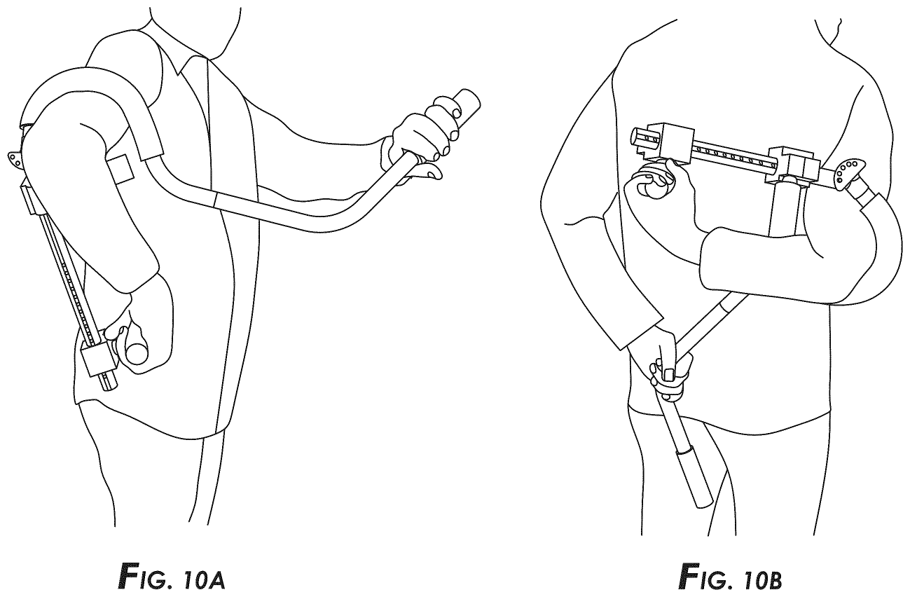

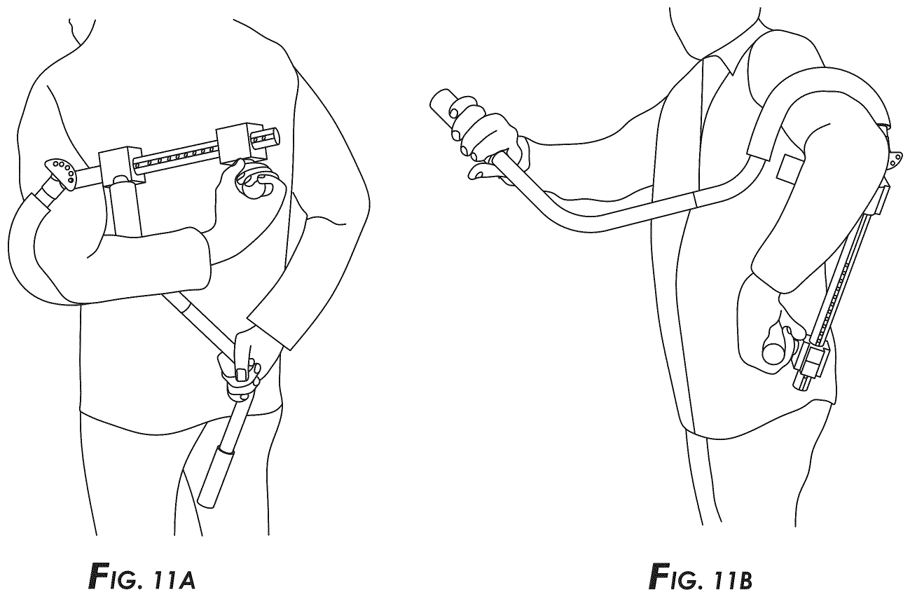

The shoulder stretching device 100 can be used to stretch and/or strengthen a variety of muscles in or around the shoulder region. Non-limiting examples of muscles that can be targeted using the shoulder stretching device and position of a user's arm include supraspinatus muscle- abducts (raises) shoulder to the side; infraspinatus muscle-external rotation of the shoulder; teres minor-external rotation of the shoulder; subscapularis muscle-internal rotation of the arm, assists with side abduction of the arm; and rear deltoid-external rotation and adduction of the upper arm. FIGS. 6-11B illustrate some of the different adjustments and positioning with respect to a user's body. Table 1 lists the different uses corresponding the FIGS. 6-11B. As can be seen, one or more components of the shoulder stretching device and the position can be used to stretch different targeted muscles.

TABLE 1

| Figure # | Type of Rotation | Arm | Relationship to body | Muscle group |
|---|---|---|---|---|
| 6 | External | Right | Front | Supraspinatus |
| | | | | Infraspinatus |
| | | | | Teres Minor |
| 7 | External | Right | Front | Supraspinatus |
| | | | | Infraspinatus |
| | | | | Teres Minor |
| 8 | External | Left | Front | Supraspinatus |
| | | | | Infraspinatus |
| | | | | Teres Minor |
| 9 | External | Left | Front | Supraspinatus |
| | | | | Infraspinatus |
| | | | | Teres Minor |
| 10A | Internal | Right | Side | Subscapularis |
| | | | | Teres Major |
| | | | | Pectoralis Major |
| 10B | Internal | Right | Back | Subscapularis |
| | | | | Teres Major |
| | | | | Pectoralis Maj |
| 11A | Internal | Left | Back | Subscapularis |
| | | | | Teres Major |
| | | | | Pectoralis Maj |
| 11B | Internal | Left | Side | Subscapularis |
| | | | | Teres Major |
| | | | | Pectoralis Maj |

A physical therapist, with or without the instruction from a doctor, can provide a user with specific exercises based on the targeted muscles, a specific injury, or a specific surgery that has been performed. The physical therapist can select the desired position of the handgrip 123, the lateral adjuster 117, and the forearm member 130 for each user and the specific exercises, for example, by utilizing the adjustment indicators 111/133 and the desired locking mechanism receivers 118 of the lateral adjuster 117 for the longitudinal member 110 adjustment. A user can perform the exercises at home with instructions from the physical therapist on how to perform the exercises with the proper location of the handgrip, angle of the longitudinal member, and forearm member with their corresponding adjustment indicator number. It is important to note that all of these muscles also play a large part in overall shoulder stability. They are critical in holding the head of the humerus in the socket of the scapula. Accordingly, the shoulder stretching device allows a user to add leverage and specifically target these muscles to stretch them in a functional position. The various adjustable components of the shoulder stretching device allow for customization to ensure proper tension on targeted muscles.

According to certain embodiments, a shoulder stretching device comprises: a longitudinal member; a handgrip operatively connected to a top end of the longitudinal member; a curved elbow member connected to a bottom end of the longitudinal member; a lateral adjuster operatively connected to the longitudinal member at a location between the handgrip and the curved elbow member; and a bottom transverse member indirectly connected to the longitudinal member via the curved elbow member, wherein adjustment of the lateral adjuster moves the handgrip closer to or farther away from the bottom transverse member. Optionally, the shoulder stretching device further comprises a vertical adjustment lock for the handgrip. Optionally, the handgrip is permanently attached to the vertical adjustment lock and is oriented perpendicularly to a longitudinal axis of the longitudinal member. Optionally, the handgrip is adjustable vertically along the longitudinal member, rotationally about the longitudinal member, or both vertically and rotationally via the vertical adjustment lock. Optionally, the handgrip is permanently attached to a side of the vertical adjustment lock, and wherein the handgrip comprises: a first straight portion extending away from the side of the vertical adjustment lock; an angled portion; and a second straight portion extending back from the first straight portion. Optionally, the handgrip is permanently attached to a back of the vertical adjustment lock, and wherein the handgrip comprises a first straight portion extending away from the back of the vertical adjustment lock, and wherein the handgrip does not comprise an angled portion or a second straight portion extending back from the first straight portion. Optionally, the top end of the longitudinal member comprises a plurality of adjustment indicators spaced a distance apart from each other for placement of the handgrip vertically along the longitudinal member. Optionally, the longitudinal member comprises a plurality of locking mechanism receivers located along an outside of the top end of the longitudinal member and adjacent to the adjustment indicators. Optionally, the lateral adjuster comprises a plurality of locking mechanism receivers. Optionally, the lateral adjuster is fan-shaped and wherein the plurality of locking mechanism receivers form an arch along an upper portion of the lateral adjuster. Optionally, the shoulder stretching device further comprises a release button permanently attached to the longitudinal member at a location adjacent to the locking mechanism receivers. Optionally, disengagement of the release button from one of the plurality of the locking mechanism receivers allows the longitudinal member to be tilted to move the handgrip closer to or farther away from the bottom transverse member. Optionally, the shoulder stretching device further comprises a forearm member located above the lateral adjuster, wherein the forearm member is adjustably connected to the longitudinal member via a forearm adjustment lock, wherein the forearm adjustment lock is configured to allow the forearm member to move along the longitudinal member, rotationally around the longitudinal axis of the longitudinal member, or both. Optionally, all of or a portion of the forearm member is covered with padding located around an outside of the forearm member. Optionally, all of or a portion of the curved elbow member is covered with padding located around an outside of the curved elbow member. Optionally, the longitudinal member, the handgrip, the curved elbow member, and the bottom transverse member have a cross-sectional shape selected from a circle, triangle, square, rectangle, or combinations of shapes. Optionally, the bottom transverse member comprises a first curved portion, a first straight portion, a second curved portion, and a second straight portion. Optionally, the first curved portion and the first straight portion form an angle θ₁, wherein the first straight portion, the second curved portion, and the second straight portion form an angle θ₂. Optionally, angle θ₁ and angle θ₂ are in a range from 95° to 150°, and wherein angle θ₁ and angle θ₂ are the same or different. Optionally, the shoulder stretching device further comprises a handgrip located at a terminal end of the second straight portion.

Therefore, the apparatus, methods, and systems of the present disclosure are well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present disclosure.

As used herein, the words “comprise,” “have,” “include,” and all grammatical variations thereof are each intended to have an open, non-limiting meaning that does not exclude additional elements or steps. While the apparatus, systems, and methods are described in terms of “comprising,” “containing,” or “including” various components or steps, the apparatus, systems, and methods also can “consist essentially of” or “consist of” the various components and steps. It should also be understood that, as used herein, “first,” “second,” and “third,” are assigned arbitrarily and are merely intended to differentiate between two or more ends, portions, etc., as the case may be, and does not indicate any sequence. Furthermore, it is to be understood that the mere use of the word “first” does not require that there be any “second,” and the mere use of the word “second” does not require that there be any “third,” etc.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

What is claimed is:

1. A shoulder stretching device comprising:
a longitudinal member;
a handgrip operatively connected to a top end of the longitudinal member;
a curved elbow member connected to a bottom end of the longitudinal member;
a lateral adjuster operatively connected to the longitudinal member at a location between the handgrip and the curved elbow member; and
a bottom transverse member indirectly connected to the longitudinal member via the curved elbow member,
wherein adjustment of the lateral adjuster moves the handgrip closer to or farther away from the bottom transverse member.

2. The shoulder stretching device according to claim 1, further comprising a vertical adjustment lock for the handgrip.

3. The shoulder stretching device according to claim 2, wherein the handgrip is permanently attached to the vertical adjustment lock and is oriented perpendicularly to a longitudinal axis of the longitudinal member.

4. The shoulder stretching device according to claim 3, wherein the handgrip is adjustable vertically along the longitudinal member, rotationally about the longitudinal member, or both vertically and rotationally via the vertical adjustment lock.

5. The shoulder stretching device according to claim 3, wherein the handgrip is permanently attached to a side of the vertical adjustment lock, and wherein the handgrip comprises: a first straight portion extending away from the side of the vertical adjustment lock; an angled portion; and a second straight portion extending back from the first straight portion.

6. The shoulder stretching device according to claim 3, wherein the handgrip is permanently attached to a back of the vertical adjustment lock, and wherein the handgrip comprises a first straight portion extending away from the back of the vertical adjustment lock, and wherein the handgrip does not comprise an angled portion or a second straight portion extending back from the first straight portion.

7. The shoulder stretching device according to claim 4, wherein the top end of the longitudinal member comprises a plurality of adjustment indicators spaced a distance apart from each other for placement of the handgrip vertically along the longitudinal member.

8. The shoulder stretching device according to claim 7, wherein the longitudinal member comprises a plurality of locking mechanism receivers located along an outside of the top end of the longitudinal member and adjacent to the adjustment indicators.

9. The shoulder stretching device according to claim 1, wherein the lateral adjuster comprises a plurality of locking mechanism receivers.

10. The shoulder stretching device according to claim 9, wherein the lateral adjuster is fan-shaped and wherein the plurality of locking mechanism receivers form an arch along an upper portion of the lateral adjuster.

11. The shoulder stretching device according to claim 9, further comprising a release button permanently attached to the longitudinal member at a location adjacent to the locking mechanism receivers.

12. The shoulder stretching device according to claim 11, wherein disengagement of the release button from one of the plurality of the locking mechanism receivers allows the longitudinal member to be tilted to move the handgrip closer to or farther away from the bottom transverse member.

13. The shoulder stretching device according to claim 1, further comprising a forearm member located above the lateral adjuster, wherein the forearm member is adjustably connected to the longitudinal member via a forearm adjustment lock, wherein the forearm adjustment lock is configured to allow the forearm member to move along the longitudinal member, rotationally around the longitudinal axis of the longitudinal member, or both.

14. The shoulder stretching device according to claim 13, wherein all of or a portion of the forearm member is covered with padding located around an outside of the forearm member.

15. The shoulder stretching device according to claim 1, wherein all of or a portion of the curved elbow member is covered with padding located around an outside of the curved elbow member.

16. The shoulder stretching device according to claim 1, wherein the longitudinal member, the handgrip, the curved elbow member, and the bottom transverse member have a cross-sectional shape selected from a circle, triangle, square, rectangle, or combinations of shapes.

17. The shoulder stretching device according to claim 1, wherein the bottom transverse member comprises a first curved portion, a first straight portion, a second curved portion, and a second straight portion.

18. The shoulder stretching device according to claim 17, wherein the first curved portion and the first straight portion form an angle θ₁, wherein the first straight portion, the second curved portion, and the second straight portion form an angle θ₂.

19. The shoulder stretching device according to claim 18, wherein angle θ₁ and angle θ₂ are in a range from 95° to 150°, and wherein angle θ₁ and angle θ₂ are the same or different.

20. The shoulder stretching device according to claim 17, further comprising a handgrip located at a terminal end of the second straight portion.
